(19) United States
(12) Patent Application Publication
(10) Pub. No.: US 2008/0305751 A1
(43) Pub. Date: Dec. 11, 2008

(54) Poc Communication System, Method for the Transmitting Poc Signalling and/or Poc Data, and a Server Device Therefor

(75) Inventor: Mirko Naumann, Gerestsried (DE)

Correspondence Address: BELL, BOYD & LLOYD, LLP, P.O. BOX 1135, CHICAGO, IL, 60690, US

(73) Assignee: NOKIA SIEMENS NETWORKS GMBH & CO, MUNICH (DE)

(21) Appl. No.: 11/910,404

(22) PCT Filed: Mar. 23, 2006
(86) PCT No.: PCT/EP2006/061004

§ 371 Date: Jun. 3, 2008

(30) Foreign Application Priority Data
Mar. 30, 2005 (DE) 10 2005 014 519.1

(51) Int. Cl. H04B 1/38

(52) U.S. Cl. 455/90.2

(57) ABSTRACT

The invention relates to a server device (S4) for connecting an independent non-PoC-compatible subscriber station (T2, T3) of a communication network (PSTN; ISDN; GSM) for pseudo PoC communication to a PoC communication system (IMS). Said server device comprises a first interface (II) as a PoC interface for creating a PoC connection (PoC) to the PoC communication system (IMS) in the manner of a PoC client; a second interface (12) for establishing a pseudo PoC connection (PoC*) to the independent non-PoC-compatible subscriber station (T2; T3) in the form of a speech communication connection; and a conversion device (TC) for converting PoC signallings and PoC data of the PoC connection (PoC) into signals and data of the pseudo PoC connection (PoC*) and vice versa. The invention also relates to a PoC communication system and a method for transmitting a PoC signalling and/or PoC data using one such server device.

PoC communication system, method for the transmission of a PoC signaling and/or of PoC data as well as a server device therefor

The invention relates to a PoC communication system with the above generic features of claim 1, to a method for the transmission of a PoC signaling and/or of PoC data with the above generic features of claim 10, or to a server device therefor.

Push-to-talk-over-Cellular (PoC, keystroke to speak over a cellular communication system) is a service based on the internet protocol (IP) for communication over two or more subscriber stations, especially mobile radio units, in a cellular communication system. With regard to the operation of the subscriber stations, PoC is carried out as with a walkie-talkie. In this mode only one subscriber can speak over their subscriber station at a particular time, such that all other subscribers can listen to the speaking subscriber over those subscriber stations which are taking part in the corresponding PoC session. That means that all subscribers can receive their speech datastream (voice stream). If a subscriber wants to speak, they must signal this to their subscriber station by pressing a correspondingly provided push-to-talk (P2T) button and waiting until their subscriber station gets allocated a corresponding token (signaling of the right to speak). Of a multitude of subscriber stations in a combined PoC session, only a single subscriber station gets the token. Only after the release of the P2T button by the subscriber on the subscriber station holding the token is the token released and can be newly allocated. Subsequently all token requests are handled according to the first come first served principle, that means that the token is allocated to that subscriber station which first requests it. There is also the possibility for prioritization, which would generate a different order. There is a multitude of applications for the PoC service. For example, short meeting arrangements between several subscribers can be taken up over PoC. Advantageous uses are also possible for the coordination of groups in the outdoors, such that, for example, groups of cyclists, mountain bikers or ramblers can use PoC sessions. What is especially advantageous in this technology is that such sessions can last the whole day, without causing costs, as in standby mode, ready to receive, no data are exchanged.

Fundamentals of the PoC are found in the corresponding preset “OMA push to talk over cellular v1.0” (OMA: Open Mobile Alliance).

For the use of this new service, subscriber stations with an IMS client (IMS: IP Multimedia Subsystem) are required on this terminal device. What is disadvantageous is that the service is therefore not useable for the mobile radio units already to be found on the market for longer, as well as the largest part of the mobile radio units currently offered on the market, for which reason the PoC service cannot be quickly converted into an economic success. For fixed network devices, conversions are quite unknown. Ultimately, however, fast convertibility is important for the investment decisions about making IMS ready on the subscriber stations.

The object of the invention consists in developing further the PoC service in such a way that a broader usability is made possible on the part of interested subscribers.

This object is achieved by a PoC communication system with the features of claim 1, by a method for transmitting a PoC signaling and/or for transmitting PoC data with the features of claim 10, or rather by a server device therefor.

Especially preferred, accordingly, is a PoC communication system (PoC: Push To Talk Over Cellular) with a PoC server for coordinating a PoC communication between PoC-enabled subscriber stations, with a server for the construction and coordination of IP-based connections in the communication system, and with a server device with a first interface as a PoC interface for the exchange of non-PoC system-based signalings and PoC-related data in the nature of a PoC client, a second interface for the exchange of non-PoC system-based signaling and data of a speech communication connection and of a conversion device for the generation of signaling and data of a speech communication connection and output of this over the second interface—for reception by an independent non-PoC-enabled subscriber station after reception of IP-based PoC signaling (IP: internet protocol), or rather PoC data through the first PoC interface, and/or for the generation of IP-based PoC signaling and PoC data for the output of these over the first PoC interface to the PoC communication system after reception of signaling and/or data for PoC transmissions through the second interface, so that the independent non-PoC-enabled subscriber station can be put to use for a PoC communication over the PoC communication system.

In addition, especially preferred accordingly is a method for the transmission of a PoC signaling and/or of PoC data, especially for the control of a server device of such a PoC communication system, in which a PoC communication connection between PoC clients is established for the transmission of PoC data with speech information content for speech transmission, and PoC signaling and/or PoC data of the PoC communication connection can be sent and/or received through at least one such PoC client over a PoC interface, such that through the client, signalings and/or data can be sent to and/or received from a non-PoC-enabled subscriber station over a second interface, and the client generates suitable signalings and/or data of one of the interfaces depending on signalings and/or data of the other interface, in order to control the non-PoC-enabled subscriber station for sending and/or receiving pseudo-PoC communication.

In addition, especially preferred accordingly is a server device to switch on an independent non-PoC-enabled subscriber station of a communication network for a pseudo-PoC communication to a PoC communication system, in particular such a server device and/or such a client as to carry out such a procedure with a first interface as a PoC interface for establishing a PoC connection to the PoC communication system in the manner of a PoC client, with a second interface for the construction of a pseudo-PoC connection to the independent non-PoC-enabled subscriber station in the manner of a speech communication connection and of a conversion device for the conversion of PoC signalings and PoC data of the PoC connection into signals and data of the pseudo-PoC connection, and vice versa.

Consequently, an independent server device is prepared, which can be prepared as an element of an IP network or as an independent component in the manner of an adapter with a subscriber. With a conversion device, this server device makes possible the connection of conventional subscriber stations without PoC capability, that means in particular without an IMS client. Correspondingly, the server device comprises the functionality of a PoC-enabled client, or rather of a PoC-enabled subscriber station, to exchange PoC signalings and PoC data over a PoC interface with the further components of the PoC communication system. In addition, the client, or rather a control device connected with the client, prepares signalings and data which make possible according to method the applicability of a non-PoC-enabled subscriber station for the PoC service over a further interface. Over the further interface, control of a conventional telephone of a conventional mobile radio device is carried out in such a way that these independent non-PoC-enabled subscriber stations become PoC-enabled, or rather pseudo-PoC-enabled.

Such a server device can be prepared as a component which can be connected to or incorporated in the PoC communication system. In addition, such a server device can be set up in front of, in or behind an actually non-PoC-enabled telephone communication system of its network operator or, as the case may be, even of a telephone user.

Consequently, the introduction of “normal” non-PoC-enabled telephones is made possible by means of a server device in the manner of a gateway server for PoC applications. Through this, PoC no longer remains imperatively reserved for a delimited number of PoC-enabled terminal devices. In addition, the applicability also becomes disposable for subscriber groups who, for example due to insufficient network coverage or for safety reasons e.g. in a hospital, otherwise cannot be served.

Through a broad base of potential subscribers, the attractiveness of the PoC service is raised. The server device can be sold as a new network element with easily recognizable added value by an operator of a mobile radio system. Through the disposability of such a server device, the base of the possible PoC is broadened considerably, so that the PoC service can quickly be offered in the areas in which mobile telephones are not usable, as the applicability is also made possible by conventional telephones connected to the cabling. Correspondingly, PoC can also be used in areas in which mobile telephones cannot or may not be used. With a conventional fixed line connection one can take part in PoC sessions over conventional telephones.

Advantageous embodiments are the subject of the dependent claims.

Especially preferred is such a PoC communication system with servers for SIP-based (SIP: Session Initiation Protocol) signaling to the establishment of connections and for the RTP data transmission for the speech data transmission (RTP: Real-time Transport Protocol).

Especially preferred is such a PoC communication system, in which the non-PoC-enabled subscriber station is a telephone of a telephone network connected by fixed lines or a mobile radio unit of a mobile network.

Especially preferred is such a PoC communication system, in which the conversion device with PoC functionality is designed as a PoC client for the PoC communication over the PoC interface and with telephone or mobile telephone functionality for a pseudo-PoC communication over the second interface.

Especially preferred is such a PoC communication system, in which the conversion device features a timer for shortening the duration of a connection to the non-PoC-enabled subscriber station.

Especially preferred is such a PoC communication system with a memory for buffering PoC data for the non-PoC-enabled subscriber station until the establishment of a speech communication connection as a pseudo-PoC connection.

Especially preferred is such a PoC communication system with a multi-frequency tone module for receiving multi-frequency signals over the second interface and for analyzing the multi-frequency signals as pseudo-PoC control signals of the non-PoC-enabled subscriber stations.

Especially preferred is such a PoC communication system with a speech analysis module for receiving speech over the second interface and for analyzing the speech as a pseudo-PoC control signal of the non-PoC-enabled subscriber station.

Especially preferred is such a method, in which signalings and data for a speech communication connection are generated and output over the second interface because of IP-based PoC signaling and/or IP-based PoC data, which are received over the PoC interface.

Especially preferred is such a method, in which a PoC signaling and/or PoC data for a PoC communication connection are generated and output over the PoC interface because of signals and/or data of a speech communication connection, which are received over the second interface.

Especially preferred is such a method, in which, across the PoC communication connection, PoC signaling and/or PoC data are received and manipulated in the manner of a PoC client and converted into signalings and data for an independent non-PoC-enabled fixed line telephone as the non-PoC-enabled subscriber station (T2), especially for an ISDN telephone.

Especially preferred is such a method, in which, across from the PoC communication connection, PoC signaling and/or PoC data are received and manipulated in the manner of a PoC client and converted into signalings and data for an independent non-PoC-enabled mobile radio unit as the non-PoC-enabled subscriber station.

Especially preferred is such a method, in which, over the second interface to the following transmission of PoC data, a cable telephone connection, in particular a speech communication connection to the non-PoC-enabled subscriber station, is constructed and subsequently PoC data are relayed to the subscriber station.

Especially preferred is such a method, in which for the assembly of a telephone connection, especially speech communication connection, a second telephone number reserved and allocated for PoC communication connections of the independent non-PoC-enabled subscriber station is dialed.

Especially preferred is such a method, in which a dialed telephone number, especially the second telephone number of an automatic call number function, is assigned to the independent non-PoC-enabled subscriber station.

Especially preferred is such a method, in which between the client and the independent non-PoC-enabled subscriber station a telephone connection is established only for a duration effective for the transmission of PoC data at hand, and/or in the case of the failure of data and/or signaling transmitted in one of the directions of transmission only for a preset duration.

Especially preferred is such a method, in which received PoC data are buffered by the clients until the establishment of a telephone connection to the independent non-PoC-enabled subscriber station.

Especially preferred is such a procedure in which the client interprets signals received from the independent non-PoC-enabled subscriber station, in particular multi-frequency tone signals as control signals for the establishment, management or termination of a PoC communication connection, and generates corresponding PoC signalings and/or PoC data and exchanges them over the PoC interface.

Especially preferred is such a method, in which the client analyses speech signals received from the independent non-PoC-enabled subscriber station, in particular speech data, and interprets predetermined speech statements as control signals for the establishment, management or termination of a PoC communication connection, and generates corresponding PoC signalings and/or PoC data and exchanges them over the PoC interface.

An exemplary embodiment is described in more detail below, with reference to the drawing, in which:

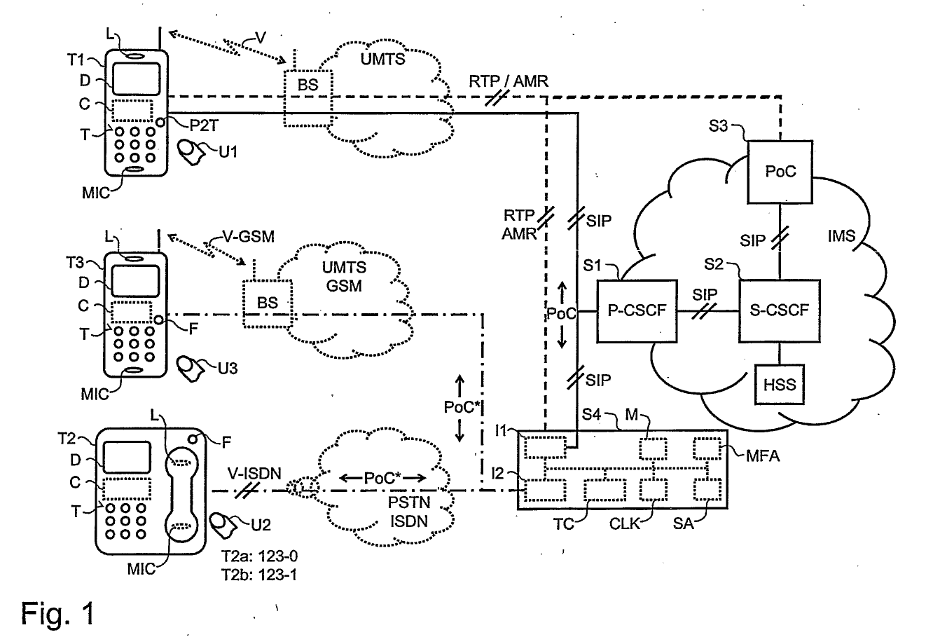

FIG. 1 shows a schematic representation of an exemplary arrangement of individual components of a PoC communication system, such that independent non-PoC-enabled subscriber stations are also integrated into the PoC service.

As is apparent from FIG. 1, in a PoC communication system diverse components and functions work together for the preparation of the PoC service. From a multitude of further necessary components, those components which are advantageous for the illustration of the concept at hand are depicted. Of course, individual components can be exchanged against other correspondingly suited components or systems, like for example intermediary radio networks UMTS, over which PoC-enabled subscriber stations T1 communicate with the network components of the network of the IMS communication system IMS. For example, with the PoC-enabled subscriber station T1 we can be dealing with a terminal device with a radio interface V, which communicates over a base stations BS of a UMTS mobile network. The introduction in a mobile network of another correspondingly suited preset or the introduction in a local radio data network (WLAN, Wireless Local Area Network) would, however, also be possible.

The exemplary depicted PoC-enabled subscriber station T1 is a terminal device with an IMS client, which enables the use of the PoC service. In a conventional way the subscriber station T1 comprises a keypad T for entering figures and numbers, a microphone MIC for inputting speech, a speaker L for the output of acoustic signals and speech, a indicator as a display device D for displaying texts and/or pictures as well as a processor as central control device C for controlling the functionality of the subscriber station T1. In order to enable the PoC service, the PoC-enabled subscriber station T1 moreover features a P2T button P2T. The P2T button is to be pressed by the user, or rather subscriber U1 of the subscriber station T1 to request a token, that means to request the right to speak in the PoC service, and to keep the token.

As per the current concepts for the PoC service, two connections are set up to establish a PoC connection between the subscriber station T1 and the IMS communication system IMS, namely a signaling connection as per SIP (Session Initiation Protocol) and a data connection as per RTP/AMR (Real Time Transport Protocol/Adaptive Multi Rate) for the transmission of subscriber data, in particular speech data.

The IMS communication system IMS preferably already uses components known in themselves of an IP-based network with an IMS proxy server S1 for the preparation of a Proxy Control State Control Function P-CSCF and with an IMS serving server S2 for the preparation of a Service Control State Control Function S-CSCF, which are in particular connected to one another over special SIP connections. The IMS serving server S2 is moreover conventionally connected with a user database HSS, in order to check authorizations and authentications of subscriber stations T1 logging on as well as their current whereabouts. The IMS communication system IMS features moreover a PoC server S3, which is connected with the IMS serving server S2 over, conventionally, an SIP connection. For the assembly of a PoC session, the subscriber station T1 takes up contact with the IMS proxy server S1 over the signaling connection SIP. For the transmission of user data, especially speech data, a likewise IP-based connection over the data connection RTP/AMR is established between the subscriber station T1 and the PoC server S3. The PoC server S3 coordinates the different subscribers of an established PoC session as well as the awarding of the token to one of the subscriber stations T1 of the PoC session. The PoC session can thereby be established by the first PoC-enabled subscriber station T1 to another PoC-enabled station, such that the subscriber U1 of the subscriber station T1 can select a desired other subscriber from an address book of the subscriber station T1 or by direct dialing with the keypad T. In principle, it is also possible to engage in an already existing PoC session, inasmuch as the entitlement to that consists, for example, on the basis of a predetermined group membership. Preferably, a multitude of different subscriber situations T1 can take part in an individual PoC session.

For the expansion of the circle of users, or rather subscribers U2, U3, with non-PoC-enabled subscriber stations T2, T3, for whom such a functionality should be made possible, a server device S4 is added to the system, which is preferably designed in the form of a gateway server. The server device S4 features a first interface as a PoC interface I1 for the exchange of PoC-related signalings and data in the manner of a PoC subscriber station with a PoC client functionality. The PoC interface I1 hence enables the assembly of a signaling connection SIP and of a user data connection RTP/AMR as IP-based connection to the IMS communication system IMS. Across from the IMS communication system IMS the server device S4 appears both structurally and functionally like an IMS client of the PoC-enabled subscriber station T1.

The server device S4 features in addition a second interface as an interface 12 for the exchange of non-PoC system-based signalings and data of a speech communication connection. Onto this second interface 12 can be connected conventional, independent non-PoC-enabled subscriber stations directly or over correspondingly intermediate communication systems PSTN, ISDN, UMTS, GSM with the server device S4. Over this second interface 12, corresponding signalings and data are exchanged in a way such that the independent non-PoC-enabled subscriber stations T2, T3 can be attached over the server device S4 to the PoC service and the IMS-PoC communication system IMS to the participation in the PoC service.

The first exemplary non-PoC-enabled subscriber T2 is a conventional cable-connected telephone with a keypad T, a processor C, a display device D and a handset with a microphone MIC and a speaker L. Moreover, such telephones conventionally feature function keys F. The connection to a telephone network takes places, for example, over an analogue connection to an analogue telephone network PSTN or over an ISDN connection V-ISDN to an ISDN telephone network. From the view of this telephone as the subscriber station T2, the server device S4 appears like a further conventional telephone as subscriber of the corresponding telephone network PSTN, ISDN.

The second exemplary non-PoC-enabled subscriber station T3 is a mobile radio unit which communicates over a radio interface V-GSM and a base station BS over a mobile network GSM, UMTS. In the conventional manner, this second non-PoC-enabled subscriber station T3 features a keypad T, a control device C, a display device D, a microphone MIC and a speaker L as well as, conventionally, one or more function keys F. From the view of this subscriber station T3, the server device S4 appears like a further subscriber station of the mobile network GSM, UMTS.

Signalings and speech data of a PoC connection in the manner of a pseudo-PoC connection PoC* are correspondingly transmitted between the non-PoC-enabled subscriber stations T2, T3 and the server device S4 in the manner of conventional data, or rather signals of a conventional speech connection.

The server device S4 features a conversion device TC, in order to prepare such pseudo-PoC signalings and pseudo-PoC data PoC* on the part of the server device S4 for the non-PoC-enabled subscriber stations T2, T3, and in order to prepare and exchange real PoC signalings und PoC data PoC over the PoC interface I1 between the server device S4 and the PoC communication system. The conversion device TC can be established by a correspondingly formed processor, which is connected with both interfaces I1, I2 and further components of the server device S4 over an internal bus. Optionally, however, all of these components and functionalities or some of the components and functionalities can also be prepared by a single processor chip or, if necessary, also by further third-party and attached external components. The conversion device TC serves to generate corresponding pseudo-PoC signalings and Pseudo-PoC data PoC* of a speech communication connection and to output this over the second interface 12 to be received by one of the non-PoC-enabled subscriber stations T2, T3 because of IP-based PoC signalings and/or PoC data received beforehand over the first interface I1. Moreover, the conversion device TC serves to generate IP-based PoC-signalings and PoC-data for the first PoC interface I1 in the reverse direction and to output over this onto the PoC communication system, after signalings and/or data for a pseudo-PoC transmission PoC* were received over the second interface I2, so that the independent non-PoC-enabled subscriber stations T2, T3 can be introduced for a PoC communication connection over the PoC-communication system IMS.

If, for example, the subscriber U1 of the PoC-enabled subscriber station T1 wants a PoC connection to the first non-PoC-enabled subscriber station T2, then this is dialed from the point of view of the subscriber T1 as if a PoC-enabled subscriber were dialed. Actually dialed is an address of the server device S4, which emerges as the actual PoC subscriber station. In what follows the server device S4 commences a conventional call connection to the non-PoC-enabled subscriber station T2. After the subscriber U2 picks up the handset, the existence of a PoC connection is signaled on the side of the server device S4 opposite the PoC server S3, so that the token can be sent to the subscriber of the calling PoC subscriber station T1. Subsequently, speech information arriving in the server device S4 in the form of speech data packets are converted from the first interface I1 to the second interface 12 and transmitted as conventional telephone network data onto the subscriber station called T2. The termination of the PoC connection can, for example, be carried out by either one of the two subscribers U1, U2 hanging up.

In order to avoid long, regular telephone connections over the conventional telephone network PSTN, ISDN or, as the case may be, the conventional mobile network UMTS, GSM, with correspondingly high line rental charges and a blocking of the telephone extension for further telephone connections, the connection to the independent non-PoC-enabled subscriber station T2, T3 is nevertheless interrupted and ended by the server device S4, e.g. an internal timer CLK, so that after the expiry of a predetermined dead time after the arrival of the last PoC data from the PoC communication system the connection to the conventional telephone network PSTN, ISDN is interrupted. On arrival of further PoC speech data from the PoC communication system, the server device S4 then assembles anew a speech connection to the independent non-PoC-enabled subscriber station T2, T3. In order not to lose the arrived speech data until the assembly of the connection, this is advantageously buffered in a storage device M of the server device S4 and transmitted after establishing the connection with something of a time offset.

In the case of an independent non-PoC-enabled subscriber station T2 which can be called for example over an ISDN connection over two independent cables, two different subscriber number T2a: 123-0 and T2b: 123-1 are preferably allocated to such a subscriber station T2. The first of the subscriber numbers T2a serves to establish conventional speech connections. The second of the subscriber numbers T2b serves rather to establish a pseudo-PoC-connection PoC*. Through this, the second subscriber numbers T2b can be dialed for the establishment of a PoC connection directly from the server device S4. The subscriber U2 of the subscriber station T2 then called can recognize by an acoustic or optical signaling that it is dealing with a PoC call. Especially preferred is a design with an automatic call pickup, which is allocated to the second subscriber number T2b, or rather the one allocated to the PoC service, so that an incoming call over this second subscriber number T2b is directly accepted and placed on the speaker L.

For an assembly of a pseudo-PoC connection PoC* on the part of one of the non-PoC-enabled subscriber stations T2, T3, there is chosen from those subscribers U2, U3 a telephone number which is allocated to the server device S4, or rather the second interface 12 of the server device S4. The server device S4 recognizes the wish to assemble a PoC connection PoC over the PoC communication system, and assembles a corresponding PoC connection in the PoC communication system IMS over the PoC interface I1. In order to inform the server device S4 which other subscriber station T1 is to have a PoC connection to it assembled, those impulse signals or multi-frequency tones can be transferred by corresponding entry on the keypad T of the calling subscriber station T2, T3 to the server device S4, depending on the type of the calling subscriber station T2, T3. The server device S4 then converts these received signalings by means of the conversion device TC and/or a multi-frequency module MFA.

According to an especially preferred design, the server device S4 features a speech analysis module SA or a corresponding functionality of the conversion device TC. The speech analysis module SA analyses speech signals received from the subscriber U2, U3 according to keywords, like e.g. “talk” or “over”, which are known as codewords, or rather commands, for requesting permission to speak, or rather for giving permission to speak taken from the use of walkie-talkies. If the password “talk” is recognized though speech analysis, then the same signaling is initiated as if the corresponding user U2, U3 were pressing and holding the P2T button P2T. Through later recognition of the command “over” in the speech signal, an end to the pressing of the P2T button is simulated and a corresponding functionality ended. Through this the user of the independent non-PoC-enabled subscriber station T2, T3 can enact control of PoC functionalities by means of spoken orders.

As per the apparatus and the method, a server is hence prepared as a gateway server device S4 or as another device with comparable functionality which on the one hand terminates a speech call (voice call) to user-defined telephones, especially over a cable connection, and which on the other hand works as a PoC client and represents the subscriber of the “normal” telephone in a PoC session. The server device can also be developed in such a way that is calls the “normal” telephone during corresponding activities in the PoC session and keeps the subscriber of the telephone building the corresponding subscriber station T2, T3 informed. In particular, this subscriber can be kept informed about speech information and also about the opening or closing of the PoC session. Such a recall would, however, take care that the costs, which with cable connections are calculated on a time basis, remain within the scale. The server device S4 can be offered by the operator of the PoC communication system as a so-called Call-in-service, such that a PoC session in which the subscriber U2, U3 wishes to take part can be marked out by an identification number, as is known from teleconferencing. The PoC communication system can be a user-defined IP-based data network with corresponding functionalities.

In what follows, individual aspects are repeated which are especially to be highlighted for understanding. The subscriber U1 on the first terminal, or rather on the first subscriber station T1 possesses a PoC-enabled mobile telephone or is called over such a server device. The subscriber U2, U3 on the second terminal, or rather the second subscriber station T2, T3 possesses a fixed line telephone or mobile telephone which is non-PoC-enabled. The server device S4 forms a gateway server which connects the second subscriber U2, U3, or rather their subscriber station T2, T3, with a PoC server S3, and so makes it possible to take part in a PoC session PoC. The PoC communication system IMS, or rather its network, accordingly features a proxy server S1 and a serving server S2, as are specified by 3GPP for IMS, for example. A first procedural example is represented by the link connection through a PoC-enabled subscriber station T1 with an invitation to a non-PoC-enabled subscriber station T2. A Session Initiation Protocol User Agent (SIP UA), which has logged on as a subscriber U2 in the PoC communication system IMS, runs already on the PoC server S3 for the second subscriber station T2, for example. The first subscriber U1 on the first subscriber station T1 opens a PoC session by means of an SIP invitation (SIP-Invite) and thereby invites the second subscriber U2, or rather their subscriber station T2. The PoC server S3 directs the invitation to the server device S4, which calls second subscriber station T2. If the subscriber U2 reaches the second subscriber station T2, then the server device S4 confirms the acceptance of the PoC session. Both subscribers U1, U2 are subsequently connected over PoC session. The second subscriber U2 can thereby control the PoC session, or rather on its side of the pseudo-PoC session PoC*, over the entry of multi-frequency tones, for example, in order to request or hand over a token. Actions of the first subscriber U1 are relayed to the second subscriber U2 by means of the server device S4 over speech instructions, for example.

According to a further procedural example in the reverse connection assembly direction, a second subscriber U2 wants by means of their independent non-PoC-enabled telephone as a second subscriber station T2 to build a connection to the subscriber U1 of the first, PoC-enabled subscriber station T1 and to call this. To this end, the server device S4 is called by the second subscriber station T2. By means of multi-frequency tones or other means of signaling, a PoC session can be initiated with the desired subscriber, or, as the case may be, also with predefined groups. To this end, the server device S4 sends a corresponding invitation over the proxy server S1 and the serving server S2 to the PoC server S3. The latter relays the invitation over the serving server S2 and the proxy server S1 to the first subscriber station T1 called. If the subscriber U1 accepts the invitation of the first subscriber station T1, then both subscriber stations T1, T2 subsequently find themselves in a PoC session, or rather in a pseudo-PoC session PoC*. The control, or rather termination, can take place as described.

1. A PoC communication system (PoC: Push to Talk Over Cellular) with
a PoC server (S3) to coordinate a PoC communication between PoC-enabled subscriber stations (T1) and
a server (S1, S2) to establish and coordinate IP-based connections in the communication system,
characterized by
a server device (S4) with
a first interface as a PoC interface (I1) to exchange PoC-related signalings (SIP) and PoC-related data (PoC, RTP/AMR) in the manner of a PoC client,
a second interface (I2) to exchange non-PoC system-based signaling and data of a speech communication connection and
a conversion device (TC) to generate signaling and data of a speech communication connection and to output this over the second interface (I2) for reception by an independent non-PoC-enabled subscriber station (T2, T3) after reception of IP-based PoC signaling (IP: Internet Protocol), or rather PoC data by the first PoC interface (I1); and/or to generate IP-based PoC signaling and PoC data so this is output over the first PoC interface (I1) onto the PoC communication system after reception of signaling and/or data for PoC transmissions through the second interface (I2), so that the independent non-PoC-enabled subscriber station (T2, T3) can be introduced for a PoC communication over the PoC communication system.

2. The PoC communication system as claimed in claim 1,
with servers (S1, S2) for SIP-based (SIP: Session Initiation Protocol) signaling for assembling connections and for RTP data transmission for speech data transmission (RTP: Real-time Transport Protocol).

3. The PoC communication system as claimed in claim 1,
in which the non-PoC-enabled subscriber station (T2) is a telephone of a cable-connected telephone network (PSTN; ISDN).

4. The PoC communication system as claimed in claim 1,
in which the non-PoC-enabled subscriber station (T3) is a mobile radio unit of a mobile network (GSM; UMTS).

5. The PoC communication system as claimed in a preceding claim 1,
in which the conversion device (TC) is assembled with PoC functionality as PoC client for the PoC communication over the PoC interface (I1) and with telephone or mobile phone functionality for a pseudo-PoC communication (PoC*) over the second interface (I2).

6. The PoC communication system as claimed in claim 1,
in which the conversion device (TC) features a timer (CLK) to shorten the duration of a connection to the non-PoC-enabled subscriber station (T2; T3).

7. The PoC communication system as claimed in claim 1
with a memory (M) to buffer PoC data for the non-PoC-enabled subscriber station (T2; T3) until assembly of a speech communication connection as pseudo-PoC connection (PoC*).

8. The PoC communication system as claimed in claim 1
with a multi-frequency module (MFA) to receive multi-frequency signals over the second interface (I2) and to analyze the multi-frequency tone signals as pseudo-PoC control signals of the non-PoC-enabled subscriber station (T2; T3).

9. The PoC communication system as claimed in claim 1
with a speech analysis module (SA) to receive speech over the second interface (I2) and to analyze the speech as pseudo-PoC control signal of the non-PoC-enabled subscriber station (T2; T3).

10. A method for transmitting a PoC signaling (SIP) and/or PoC data (PoC, RTP), especially to control a server device (S4) of a PoC communication system (IMS) according to a preceding claim, in which
a PoC communication connection (PoC) between PoC clients (T1) is assembled to transmit PoC data with speech information content for speech transmission and
PoC signaling and/or PoC data of the PoC communication connection are sent and/or received through at least one such PoC client over a PoC interface (I1),
characterized in that
signaling and/or data are sent and/or received by the clients (S3) over a second interface (I2) to a non-PoC-enabled subscriber station (T2; T3) and
the client (S3) generates suitable signalings and/or data of one of the interfaces (I2; I1) depending on signalings and/or data of the other interface (I1; I2), in order to send the non-PoC-enabled subscriber station (T2; T3) and/or to control receipt of pseudo-PoC communication.

11. The method as claimed in claim 10,
in which signalings and data for a speech communication connection are developed and output over the second interface (I2) because of IP-based PoC signaling and/or IP-based PoC data, which are received over the PoC interface (I1).

12. The method as claimed in claim 10,
in which a PoC signaling and/or PoC data are generated for a PoC communication connection and output over the PoC interface (I1) because of signals and/or data of a speech communication connection, which are received over the second interface (I2).

13. The method as claimed in claim 10,
in which PoC signaling and/or PoC data are received opposite the PoC communication connection and manipulated in the manner of a PoC client and converted into signalings and data for an independent non-PoC-enabled fixed line telephone as of the non-PoC-enabled subscriber station (T2), especially for an ISDN telephone.

14. The method as claimed in claim 10,
in which PoC signaling and/or PoC data are received opposite the PoC communication connection and manipulated in the manner of a PoC client and converted into signalings and data for an independent non-PoC-enabled mobile radio unit (T3) as of the non-PoC-enabled subscriber station (T3).

15. The method as claimed in claim 10,
in which a cable telephone connection, in particular a speech communication connection (ISDN) to the non-PoC-enabled subscriber station (T2; T3), is assembled over the second interface (I2) for the subsequent transmission of PoC data, and subsequently PoC data are relayed on to the subscriber station (T2; T3).

16. The method as claimed in claim 10,
in which for the assembly of a telephone connection, in particular speech communication connection (ISDN), a second telephone number (T2b) reserved for and assigned to PoC communication connections of the independent non-PoC-enabled subscriber station (T2) is dialed.

17. The method as claimed in claim 10,
in which a dialed telephone number, especially the second telephone number (T2b) is allocated to an automatic call taking function of the non-PoC-enabled subscriber station (T2).

18. The method as claimed in claim 10,
in which between the client (S4) and the independent non-PoC-enabled subscriber station (T2; T3) a telephone connection is established only for a duration effective for the transmission of PoC data at hand, and/or in the case of the failure of data and/or signaling transmitted in one of the directions of transmission only for a preset duration.

19. The method as claimed in claim 10,
in which PoC data received by the clients (S4) are buffered until the establishment of a telephone connection to the independent non-PoC-enabled subscriber station (T2; T3).

20. The method as claimed in claim 10,
in which the client (S4) interprets signals received from the independent non-PoC-enabled subscriber station (T2; T3), in particular multi-frequency tone signals as control signals for the establishment, management or termination of a PoC communication connection, and generates corresponding PoC signalings and/or PoC data and exchanges it over the PoC interface (I1).

21. The method as claimed in claim 10,
in which the client (S3) analyses speech signals received from the independent non-PoC-enabled subscriber station (T2; T3), in particular speech data, and interprets predetermined spoken instructions as control signals for the establishment, management or termination of a PoC communication connection, and generates corresponding POC signalings and/or PoC data and exchanges them over the PoC interface (I1).

22. A server device (S4) for attaching an independent non-PoC-enabled subscriber station (T2, T3) of a communication network (PSTN; ISDN; GSM) for a pseudo-PoC communication to a PoC communication system (IMS), in particular server device (S4) according to one of the claims 1 to 9 and/or client (S4) for carrying out a method according to one of the claims 10 to 21, with
a first interface (I1) as a PoC interface for establishing a PoC connection (PoC) to the PoC communication system (IMS) in the manner of a PoC client,
a second interface (I2) for establishing a pseudo-PoC connection (PoC*) to the independent non-PoC-enabled subscriber station (T2; T3) in the manner of a speech communication connection and
a conversion device (TC) for converting PoC signalings and PoC data of the PoC connection (PoC) into signals and data of the pseudo-PoC-connection (PoC*), and vice versa.
